(19) United States
(12) Patent Application Publication
(10) Pub. No.: US 2011/0225654 A1
(43) Pub. Date: Sep. 15, 2011

(54) Write-Proof Protection Method of a Storage Device

(76) Inventors: Mao-Huai Weng, San-Chung City (TW); Wen-Chu Chuang, San-Chung City (TW); Chun-Tai Chen, San-Chung City (TW)

(21) Appl. No.: 12/197,369

(22) Filed: Aug. 25, 2008

(51) Int. Cl. G06F 21/00

(52) U.S. Cl. 726/24

(57) ABSTRACT

The present invention is a write-proof protection method of a storage device. The storage device includes a buffer to store data temporarily, with a capacity of the buffer being adjustable; and a write-proof control unit. The write-proof protection method includes transmitting a write-in protection signal to the write-proof control unit from an operating unit; the write-proof control unit writing a file that is written into a computer into the buffer of the storage device, rather than a file system. When a stand-alone write-proof condition has been set by a user, an unknown program that has been written in can be a virus pattern, and the unknown program in the buffer can be analyzed to discover a new virus early, so as to achieve an antivirus effect.

### BACKGROUND OF THE INVENTION

a) Field of the Invention

The present invention relates to a write-proof protection method of a storage device, and more particularly to a write-proof protection method of a storage device, which can detect write-in of a virus pattern or an unknown program, and store that program code as a file for a succeeding analysis and comparison.

b) Description of the Prior Art

To protect data from being incautiously overridden that it is lost or infected with viruses, an ordinary storage device is usually provided with a write-proof protection function which can be implemented by a hardware or software. A common storage device, such as a personal disk, is usually provided with a write-proof switch at a side thereof; whereas, a side or a surface of a memory card is also provided with a write-proof switch, for switching the memory card to the write-proof protection condition that data can only be read but not written in. An external hard disk is also provided with a write-proof protection lock at a hard disk drive case to keep data from being overwritten. When a computer system has detected the write-proof condition of the storage device, a message saying that data cannot be written into the storage device will occur. On the other hand, if an unknown program tries to be written in, then it will also be blocked out.

The conventional write-proof protection function can only prevent the storage from being written into by a file. Although the data in the storage device can be effectively prevented from being incautiously overwritten, and the storage device can be prevented from being intruded by viruses, the unknown programs which are possibly problematic cannot be discovered. If the unknown program is trying to be written into the storage device even under the write-proof condition, then it is possible a virus pattern. If this virus pattern is a new virus program, and an antivirus software company has not discovered this new virus pattern yet, then this new virus program cannot be analyzed and an antivirus pattern cannot be programmed according to its characteristics; therefore, the antivirus pattern cannot be added into a data base to serve as a base to identify the virus pattern for a virus sweeping program. For the antivirus software which cannot detect the new virus pattern, it is very important to early discover the new virus pattern and to early analyze the new virus pattern. Therefore, in spite that the computer has been already installed with the antivirus software, the virus sweeping program is still unavailable to detect the new virus pattern, and a probability that the computer will be intruded by the unknown program will be increased significantly. Usually, the antivirus software is able to protect from the virus only after the virus pattern has been discovered and analyzed, and an undiscovered new virus pattern may be spreading quickly through computers, networks or portable storage media, causing data to be severely damaged. Accordingly, if the new virus program can be discovered and analyzed early, and an antivirus method can be provided early, then a severe loss to an individual or an enterprise can be avoided.

### SUMMARY OF THE INVENTION

The primary object of the present invention is to provide a write-proof protection method of a storage device, such that when the storage device is set at a stand-alone write-proof condition, that stand-alone write-proof condition is not detected by an electronic device. Therefore, a file can be still written into the storage device and can be written into a buffer rather than a file system, so as to detect write-in of an unknown program and to store that program code as a file for a succeeding analysis, enabling a new virus to be discovered early, thereby achieving an antivirus effect.

Accordingly, a storage device of the present invention is provided with a buffer to store data temporarily, with a capacity of the buffer being adjustable; and a write-proof control unit to control whether a file to be written in is to be written into the buffer or the file system. In addition, the storage device is connected to an electronic device.

A write-proof protection method of the storage device includes transmitting a write-in protection signal to the write-proof control unit from an operating unit; and writing the file into the buffer of the storage device rather than the file system, when a write-in command is received by the write-proof control unit from the electronic device.

When a user has set the storage device at the stand-alone write-proof condition, the write-in protection signal is received by the write-proof control unit. At this time, the electronic device will think that the storage device is at a normal read-write condition; and hence, the file can be written in. However, in reality, the file is not written into the file system, rather than that the file or program code that has been written in is led to the buffer by the write-proof control unit. When the buffer is full, a message saying that data is not able to be written into the buffer will occur.

When the user has set the storage device at the stand-alone write-proof condition, except that he or she forgets to result in a write-in operation, if the unknown program is trying to be written in, then it is possible that a virus pattern is intruding. Accordingly, the file in the buffer will be inspected, and the program code that has been abnormally written into the buffer will be stored as a file which is provided to the antivirus software company for the succeeding analysis, so as to discover the new virus early.

The write-proof protection method of the storage device further includes that the user can select whether to write the file that has been written into the buffer into the file system.

Therefore, in addition to that the write-proof protection method of the storage device, according to the present invention, can achieve the conventional functions that the file is prevented from being written in to keep the data from being overwritten and infected with the virus patterns, the problematic write-in can be discovered, and the unknown program can be stored to provide to the antivirus software company for the virus analysis, such that the new viruses can be discovered early to achieve the antivirus effect.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a system structure diagram of the present invention.

FIG. 2 shows a flow diagram of the present invention.

FIG. 3 shows a system structure diagram of another embodiment of the present invention.

### DETAILED DESCRIPTION OF THE PREFERRED EMBODIMENTS

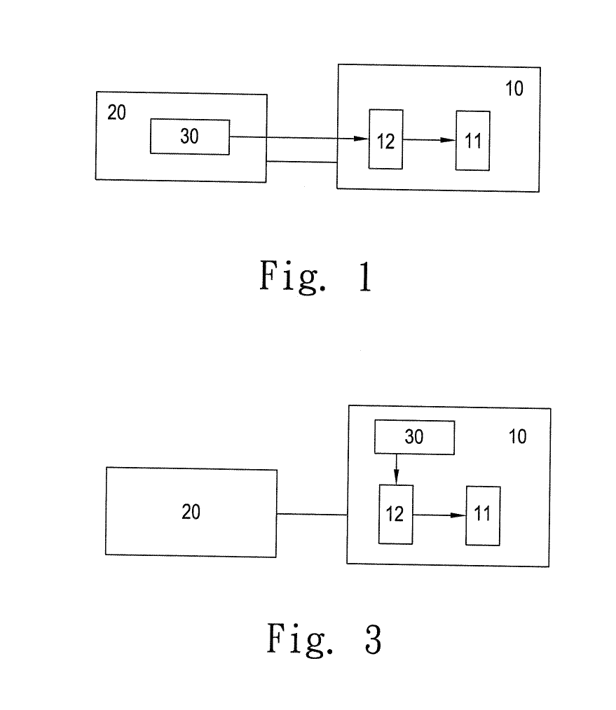

Referring to FIG. 1, it shows a system structure diagram of the present invention, wherein a storage device 10 is connected to an electronic device 20, the storage device 10 is provided with a buffer 11 and a write-proof control unit 12, and the electronic device 20 includes an operating unit 30. The storage device 10 can be a hard disk built into a computer, an external hard disk, a memory card, a personal disk or a floppy disk; and a part of memory blocks of the storage device 10 is configured as the buffer 11 to store data temporarily. In addition, a user can adjust by oneself a capacity of the buffer 11. In this embodiment, the electronic device 20 is a computer system, and the write-proof control unit 12 is a firmware which is built into the storage device 10.

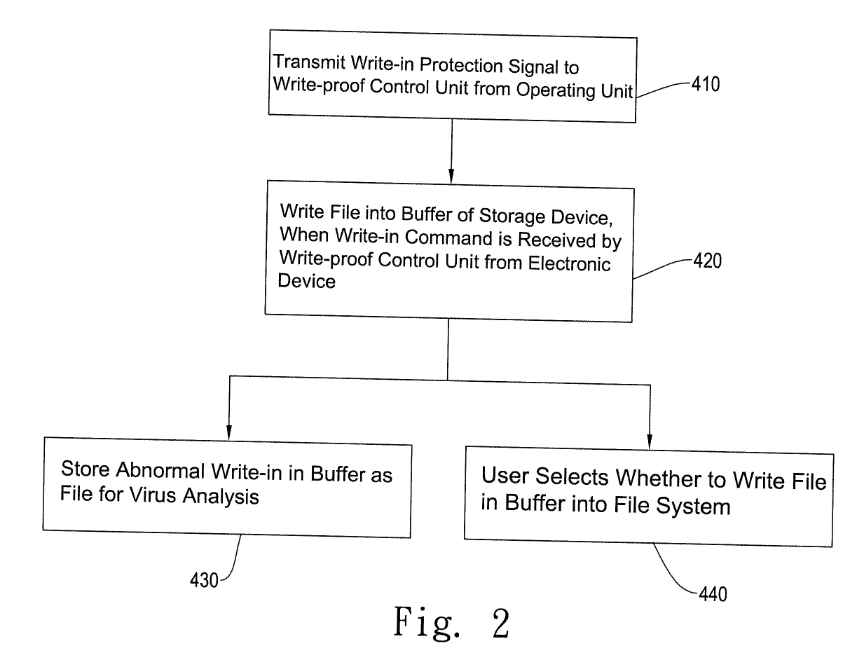

Referring to FIGS. 1 and 2, it shows a system structure diagram and a flow diagram, of the present invention, wherein a write-proof protection method comprises a step 410, which is that a write-in protection signal is transmitted to the write-proof control unit 12 from the operating unit 30; and a step 420, which is that a file is written into the buffer 11 of the storage device 10 rather than a file system, when a write-in command is received by the write-proof control unit 12 from the electronic device 20. In this embodiment, the operating unit 30 is a driver that is installed in the electronic device 20, and that driver program includes a user operating interface through which the user sets the write-proof function of the storage device 10. When the storage device 10 is set at the write-proof condition, the operating unit 30 will transmit the write-in protection signal to the write-proof control unit 12 (or the firmware) of the storage device 10. When that write-in protection signal is received by the write-proof control unit 12 from the computer, due to that the computer detects that the storage device 10 is under a normal read-write condition at this time, an operating system will not know that the storage device 10 is under the write-proof condition, and hence a file can be written in. On the other hand, the file to be written in will be led by the write-proof control unit 12 to the buffer 11. When the buffer 11 is full, a message saying that no data can be written into the buffer will occur.

When the user has set the storage device 10 at the write-proof condition, data cannot be written in by itself. Except that data is written in because the user forgets, other unknown program that attempts to be written in can be a virus. Therefore, the unknown program will be written into the buffer 11 by the write-proof control unit 12. The write-proof protection method further comprises a step 430, which is that the file that has been abnormally written in is stored as a file for a virus analysis. The file in the buffer 11 is then inspected, and it can determine that a virus is possibly intruding if there is abnormal write-in. The file that has been abnormally written in is then stored as a file which is sent to an antivirus software company for the analysis, such that a new virus can be discovered early and the new virus can be kept from quickly spreading through the storage devices, computers and networks, to result in a severe damage to an individual or an enterprise. Moreover, the write-proof protection method comprises a step 440, which is that the user can select whether to write the file that has been written into the buffer 11 into the file system of the storage device 10.

Referring to FIG. 3, it shows a system structure diagram of another embodiment of the present invention, wherein the storage device 10 is similarly provided with the buffer 11 to store data temporarily; and the write-proof control unit 12, which is a controller. The operating unit 30 is provided on the storage device 10, including a write-proof switch and a control circuit. When the stand-alone write-proof condition is switched to by that write-proof switch, the control circuit will transmit a write-in protection signal to that controller; at this time, the electronic device 20 will think that the storage device 10 is under a normal read-write condition, and a file can be written in. When the file is to be written in, the controller will write the file into the buffer 11 of the storage device 10, rather than the file system. When the buffer 11 is full, a message saying that no data can be written into the buffer will occur. The file in the buffer 11 is then inspected; if there is abnormal write-in, then the program code that has been abnormally written in can be stored as a file which is sent to the antivirus software company for the succeeding analysis, so as to discover a new virus early. On the other hand, the user can select whether to write the file that has been written into the buffer 11 into the file system of the storage device 10.

Accordingly, when the stand-alone write-proof condition has been set by the user, the file can be still written into the storage device 10. However, in reality, the file is first written into the buffer 11, rather than the file system, such that the data in the storage device 10 can be prevented from being overwritten, the storage device 10 can be prevented from being infected with the virus, and the succeeding analysis and comparison can be performed against the abnormal write-in to early discover the new virus, thereby achieving the antivirus effect.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A write-proof protection method of a storage device, wherein the storage device, which is connected to an electronic device, is provided with a buffer to store data temporarily and a write-proof control unit; the write-proof protection method comprising transmitting a write-in protection signal to the write-proof control unit from an operating unit; and writing a file into the buffer of the storage device rather than a file system, when a write-in command is received by the write-proof control unit from the electronic device.

2. The write-proof protection method of a storage device according to claim 1, wherein the write-proof control unit is a firmware on the storage device, and the operating unit is a program on the electronic device, with that program including a user operating interface through which the user sets a write-proof condition of the storage device.

3. The write-proof protection method of a storage device according to claim 1, wherein the operating unit is a write-proof switch and a control circuit that are installed on the storage device, and the write-proof control unit is a controller on the storage device.

4. The write-proof protection method of a storage device according to claim 1, further comprising that a message saying no data is able to be written into the buffer occurs when the buffer is full.

5. The write-proof protection method of a storage device according to claim 1, further comprising that abnormal write-in in the buffer is stored as a file for an analysis.

6. The write-proof protection method of a storage device according to claim 1, further comprising that the user selects whether to write the file that has been written into the buffer into the file system.

7. The write-proof protection method of a storage device according to claim 1, wherein the electronic device is a computer system.

8. The write-proof protection method of a storage device according to claim 1, wherein the electronic device is a hard disk.

9. The write-proof protection method of a storage device according to claim 1, wherein the electronic device is a memory card or a personal disk.

10. The write-proof protection method of a storage device according to claim 1, wherein a capacity of the buffer is adjustable.
